(19) United States
(12) Patent Application Publication
(10) Pub. No.: US 2021/0064815 A1
(43) Pub. Date: Mar. 4, 2021

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventor: Arihito TAKAGI, Kanagawa (JP)

(73) Assignee: FUJI XEROX CO., LTD., Tokyo (JP)

(21) Appl. No.: 16/781,005

(22) Filed: Feb. 4, 2020

(30) Foreign Application Priority Data
Aug. 30, 2019 (JP) 2019-158715

(51) Int. Cl. G06F 40/174; G06K 9/00; G06F 40/177

(52) U.S. Cl. CPC G06F 40/174; G06F 40/177; G06K 9/00463

(57) ABSTRACT

An information processing apparatus includes a processor. The processor is configured to accept designation of an area including an item and a set of one or more options for the item, the item being contained in a form image to be recognized, to define the form image, extract the item and the set of one or more options from the area, and perform control to display a definition that associates the item with the set of one or more options.

### CROSS-REFERENCE TO RELATED APPLICATIONS

This application is based on and claims priority under 35 USC 119 from Japanese Patent Application No. 2019-158715 filed Aug. 30, 2019.

### BACKGROUND

### (i) Technical Field

The present disclosure relates to an information processing apparatus and a non-transitory computer readable medium.

### (ii) Related Art

For example, Japanese Patent No. 4183527 describes a form definition data generation method for automatically generating form definition data for various forms. The form definition data generation method includes obtaining form image data from a blank form or a filled-in form, and extracting layout information, such as tables, frames, and ruled lines, from the form image data. The form definition data generation method further includes extracting, from layout information corresponding to a definition area designated by a user using an input device, first definition data regarding the position of the definition area, and performing character recognition processing on portions within frames located above and to the left of the definition area, a portion within the definition area, and portions outside the frames located above and to the left of the definition area, in this order. The form definition data generation method further includes stopping, in response to obtaining of a recognition result in the character recognition processing of each of the portions, the character recognition processing on the subsequent portions, matching the recognition result against words that can be keywords, and converting an obtained keyword into second definition data regarding the property of the definition area.

### SUMMARY

In some cases, a form image contains an item having a set of options such as those which are to be checked by check marks or enclosed in borders. To define the set of options, a user manually selects, from among a plurality of frames extracted from the form image, individually a frame for the item and frames for the options for the item so as to define the item and the options for the item in association with each other.

Aspects of non-limiting embodiments of the present disclosure relate to an information processing apparatus and a non-transitory computer readable medium that enable display of, in response to acceptance of designation of an area including an item and a set of options for the item in a form image containing items each having a set of options, a definition that associates the item with the set of options.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor. The processor is configured to accept designation of an area including an item and a set of one or more options for the item, the item being contained in a form image to be recognized, to define the form image, extract the item and the set of one or more options from the area, and perform control to display a definition that associates the item with the set of one or more options.

### BRIEF DESCRIPTION OF THE DRAWINGS

An exemplary embodiment of the present disclosure will be described in detail based on the following figures, wherein:

FIG. 1 illustrates an example configuration of a form processing system according to the exemplary embodiment;

FIG. 2 is a block diagram illustrating an electrical configuration of a server apparatus according to the exemplary embodiment;

FIG. 3 illustrates a method for defining an item having a plurality of check boxes to which check marks are applicable according to a comparative example;

FIG. 4 illustrates the method for defining an item having a plurality of check boxes to which check marks are applicable according to the comparative example;

FIG. 5 illustrates the method for defining an item having a plurality of check boxes to which check marks are applicable according to the comparative example;

FIG. 6 illustrates a method for defining an item having a plurality of character strings around which borders are applicable according to a comparative example;

FIG. 7 illustrates the method for defining an item having a plurality of character strings around which borders are applicable according to the comparative example;

FIG. 8 illustrates the method for defining an item having a plurality of character strings around which borders are applicable according to the comparative example;

FIG. 9 illustrates the method for defining an item having a plurality of character strings around which borders are applicable according to the comparative example;

FIG. 10 is a block diagram illustrating an example functional configuration of the server apparatus according to the exemplary embodiment;

FIG. 11 is a flowchart illustrating an example flow of a process performed in accordance with an information processing program according to the exemplary embodiment;

FIG. 12 illustrates an example of a form image and an option definition for options to be checked by check marks according to the exemplary embodiment;

FIG. 13 illustrates an example of the form image according to the exemplary embodiment in which an area is designated;

FIG. 14 illustrates an example of the form image according to the exemplary embodiment in which ruled lines are detected from within the area;

FIG. 15 illustrates an example of the form image according to the exemplary embodiment in which the area is divided into a plurality of groups;

FIG. 16 illustrates an example of a form image and an option definition for options to be enclosed in borders according to the exemplary embodiment;

FIG. 17 illustrates an example of the form image according to the exemplary embodiment in which an area is designated;

FIG. 18 illustrates an example of the form image according to the exemplary embodiment in which ruled lines are detected from within the area; and

FIG. 19 illustrates an example of the form image according to the exemplary embodiment in which the area is divided into a plurality of groups.

### DETAILED DESCRIPTION

The following describes an exemplary embodiment of the present disclosure in detail with reference to the drawings.

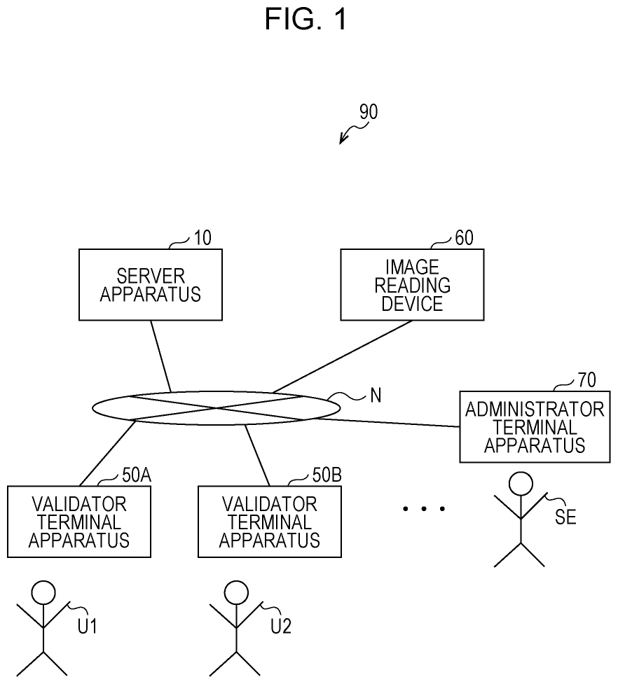

FIG. 1 illustrates an example configuration of a form processing system 90 according to this exemplary embodiment.

As illustrated in FIG. 1, the form processing system 90 according to this exemplary embodiment includes a server apparatus 10, validator terminal apparatuses 50A, 50B, etc., an image reading device 60, and an administrator terminal apparatus 70. The server apparatus 10 is an example of an information processing apparatus.

The server apparatus 10 is connected so as to be capable of communicating with the validator terminal apparatuses 50A, 50B, etc., the image reading device 60, and the administrator terminal apparatus 70 via a network N. Examples of the server apparatus 10 include a server computer and a general-purpose computer such as a personal computer (PC). Examples of the network N include the Internet, a local area network (LAN), and a wide area network (WAN).

The image reading device 60 has a function of optically reading a paper form to obtain an image and transmitting the obtained image (hereinafter referred to as “form image”) to the server apparatus 10. The term “form”, as used herein, refers to any document form containing a plurality of fields of items such as name and address fields. In the form, each of the plurality of fields of items is filled out with handwritten characters, printed characters, or the like. Specifically, as described below, the server apparatus 10 performs optical character recognition (OCR) processing on the form image received from the image reading device 60 to acquire a recognition result of an image corresponding to each of the plurality of fields of items. Examples of the recognition result include a character string indicating a sequence of characters containing one or more letters. In the form, areas to be filled in, which correspond to the fields of items, are bounded by frames or the like, and the areas to be filled in are defined as areas to be subjected to recognition. OCR processing is performed on the defined areas to acquire character strings for the respective images corresponding to the plurality of fields of items.

The validator terminal apparatus 50A is a terminal apparatus operated by a validator (user) U1 who performs a validation operation, and the validator terminal apparatus 50B is a terminal apparatus operated by a validator U2 who performs a validation operation. The validator terminal apparatuses 50A, 50B, etc. are also referred to collectively as “validator terminal apparatuses 50” or individually as “validator terminal apparatus 50” unless the validator terminal apparatuses 50A, 50B, etc. need be distinguished from each other. Also, the validators U1, U2, etc. are also referred to collectively as “validators U” or individually as “validator U” unless the validators U1, U2, etc. need be distinguished from each other. Examples of the validator terminal apparatus 50 include a general-purpose computer such as a PC, and a portable terminal apparatus such as a smartphone and a tablet terminal. The validator terminal apparatus 50 has installed therein a validation application program (hereinafter referred to also as “validation application”) for allowing the validator U to perform a validation operation. The validator terminal apparatus 50 generates and displays a validation operation user interface (UI) screen. The term “validation” or “validation operation”, as used herein, refers to an operation of validating (and correcting, if any) a recognition result of characters or the like in the form image.

The administrator terminal apparatus 70 is a terminal apparatus operated by a system administrator SE. The system administrator SE configures form definition data through a form definition screen (not illustrated). The form definition data is data used to recognize a form image, and, for example, a sheet size and information on a recognition frame (such as the item name, size, and coordinates of the recognition frame, the type of characters in the recognition frame, and a recognition dictionary) are defined. Examples of the administrator terminal apparatus 70 include a general-purpose computer such as a PC, and a portable terminal apparatus such as a smartphone and a tablet terminal.

The form image includes sub-images of fields of items (hereinafter referred to as “item images”), and each of the item images is recognized to obtain a recognition result. If the recognition result has a confidence level less than a threshold, the server apparatus 10 makes a person manually validate the recognition result. If the recognition result has a confidence level greater than or equal to the threshold, the server apparatus 10 outputs the recognition result as a final recognition result without performing any manual validation operation. The confidence level is a measure of how confident the recognition result is. The higher the value of the confidence level, the higher the probability of matching between the item image and the recognition result.

To perform the validation operation described above, the server apparatus 10 performs control to display each of the item images and a character string obtained by OCR processing on the UI screen of the validator terminal apparatus 50 in association with each other. The validator U views each of the item images and validates whether the character string corresponding to the item image is correct. As a result of the validation, if the character string is correct, the validator U performs no operation, and if the character string is not correct, the validator U inputs a correct character string on the UI screen. The validator terminal apparatus 50 transmits the character string whose input is accepted through the UI screen to the server apparatus 10 as a validation result. The server apparatus 10 outputs a final recognition result based on the validation result from the validator terminal apparatus 50, and performs control to display the final recognition result on the UI screen of the validator terminal apparatus 50.

In the validation operation described above, a type of entry indicating the method by which the validation operation is performed is set. Any one of “double entry” and “single entry” is set as an example type of entry. “Double entry” is a method in which a plurality of validators perform a validation operation, and “single entry” is a method in which a single validator performs a validation operation.

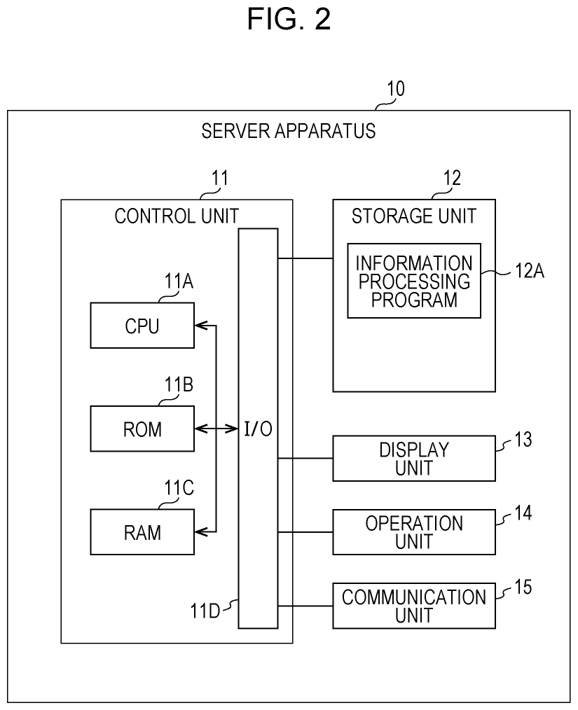

FIG. 2 is a block diagram illustrating an example electrical configuration of the server apparatus 10 according to this exemplary embodiment.

As illustrated in FIG. 2, the server apparatus 10 according to this exemplary embodiment includes a control unit 11, a storage unit 12, a display unit 13, an operation unit 14, and a communication unit 15.

The control unit 11 includes a central processing unit (CPU) 11A, a read only memory (ROM) 11B, a random access memory (RAM) 11C, and an input/output interface (I/O) 11D. The CPU 11A, the ROM 11B, the RAM 11C, and the I/O 11D are interconnected via a bus.

The I/O 11D is connected to functional units including the storage unit 12, the display unit 13, the operation unit 14, and the communication unit 15. Each of the functional units is capable of communicating with the CPU 11A via the I/O 11D.

The control unit 11 may be configured as a sub-control unit that controls part of the operation of the server apparatus 10, or may be configured as part of a main control unit that controls the overall operation of the server apparatus 10. Some or all of the blocks of the control unit 11 are implemented using, for example, an integrated circuit (IC) such as a large scale integrated (LSI) circuit or an IC chip set. Each of the blocks may be implemented as a single separate circuit, or some or all of the blocks may be integrated on a circuit. Alternatively, the blocks may be formed into a single unit, or some of the blocks may be disposed in a separate portion. In each of the blocks, a portion thereof may be disposed in a separate portion. The control unit 11 may be integrated by using a dedicated circuit or a general-purpose processor instead of by using an LSI circuit.

Examples of the storage unit 12 include a hard disk drive (HDD), a solid state drive (SSD), and a flash memory. The storage unit 12 stores an information processing program 12A according to this exemplary embodiment. The information processing program 12A may be stored in the ROM 11B.

The information processing program 12A may be installed in the server apparatus 10 in advance, for example. The information processing program 12A may be implemented as follows. The information processing program 12A may be stored in a non-volatile non-transitory storage medium or distributed via the network N and installed into the server apparatus 10, as necessary. Possible examples of the non-volatile non-transitory storage medium include a compact disc read only memory (CD-ROM), a magneto-optical disk, an HDD, a digital versatile disc read only memory (DVD-ROM), a flash memory, and a memory card.

Examples of the display unit 13 include a liquid crystal display (LCD) and an organic electroluminescent (EL) display. The display unit 13 may have a touch panel integrated therein. The operation unit 14 is provided with an operation input device such as a keyboard and a mouse. The display unit 13 and the operation unit 14 accept various instructions from the user of the server apparatus 10. The display unit 13 displays various types of information, examples of which include results of a process executed in accordance with an instruction accepted from the user, and a notification about the process.

The communication unit 15 is connected to the network N, such as the Internet, a LAN, or a WAN, and is allowed to communicate with each of the image reading device 60, the validator terminal apparatus 50, and the administrator terminal apparatus 70 via the network N.

As described above, in some cases, a form image contains an item having a set of options such as those which are to be checked by check marks or enclosed in borders. To define the set of options, a user manually selects, from among a plurality of frames extracted from the form image, individually a frame for the item and frames for the options for the item so as to define the item and the options for the item in association with each other.

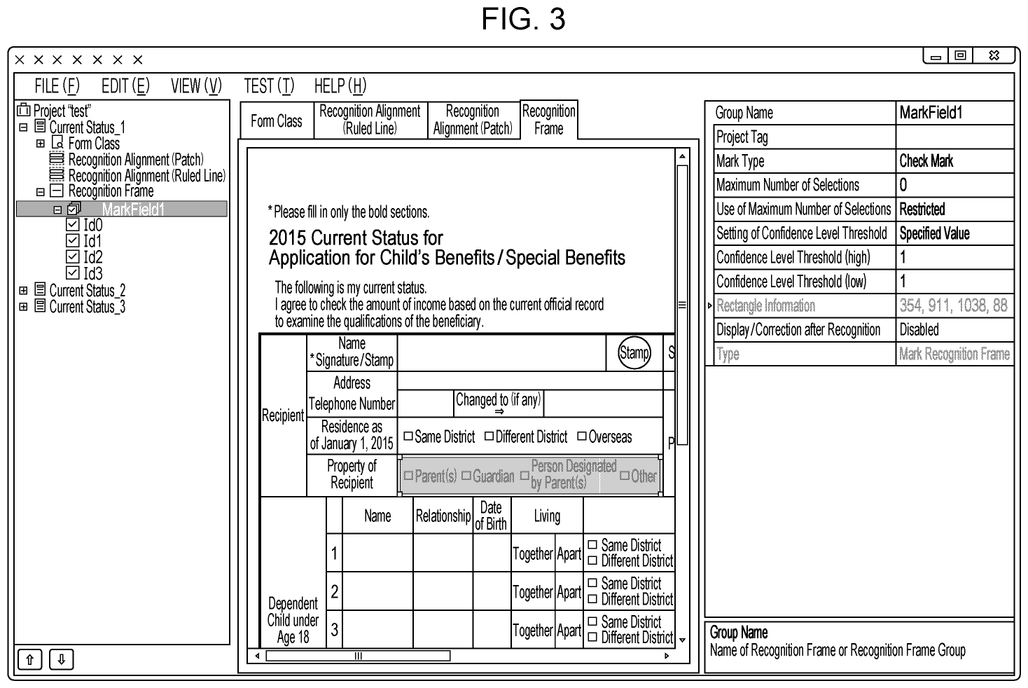

FIGS. 3 to 5 illustrate a method for defining an item having a plurality of check boxes to which check marks are applicable according to a comparative example.

For example, as illustrated in FIG. 3, a menu is displayed by a right click on a displayed form image with a mouse (not illustrated). When “Auto Detect” and “Check Mark” are selected in the menu and then the range to be defined is selected by a drag-and-drop action, check boxes are detected. Accordingly, as illustrated in FIG. 3, as an example, a frame for a main item named “MarkField1”, which corresponds to “Property of Recipient”, and frames for option items (hereinafter referred to as sub-items) named “Id0”, “Id1”, “Id2”, and “Id3”, which correspond to “Parent(s)”, “Guardian”, “Person Designated by Parent(s)”, and “Other”, respectively, are generated.

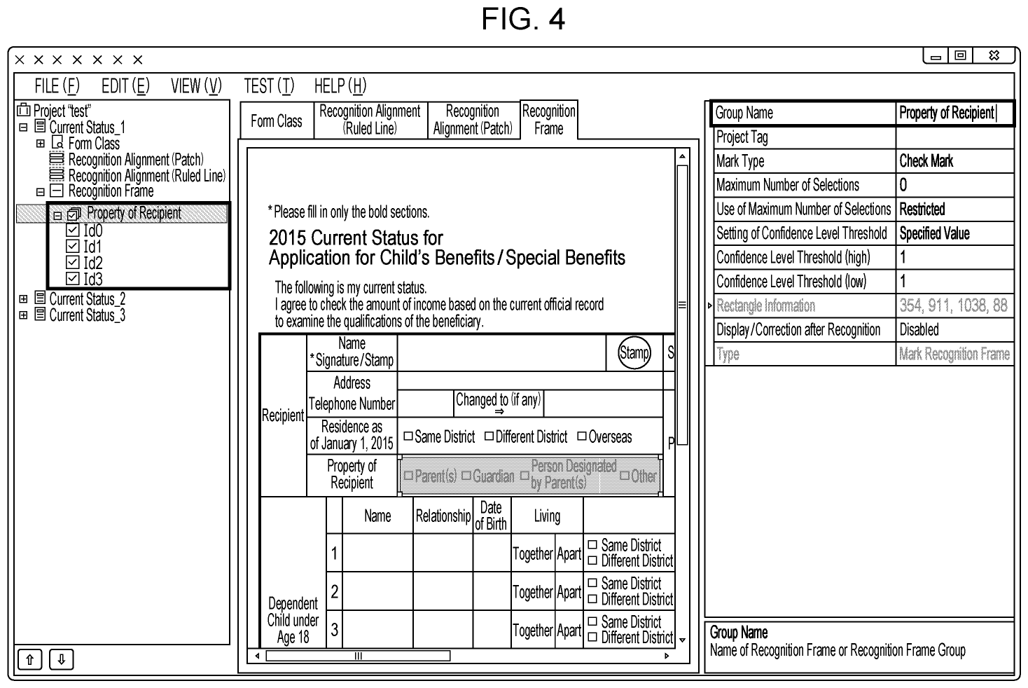

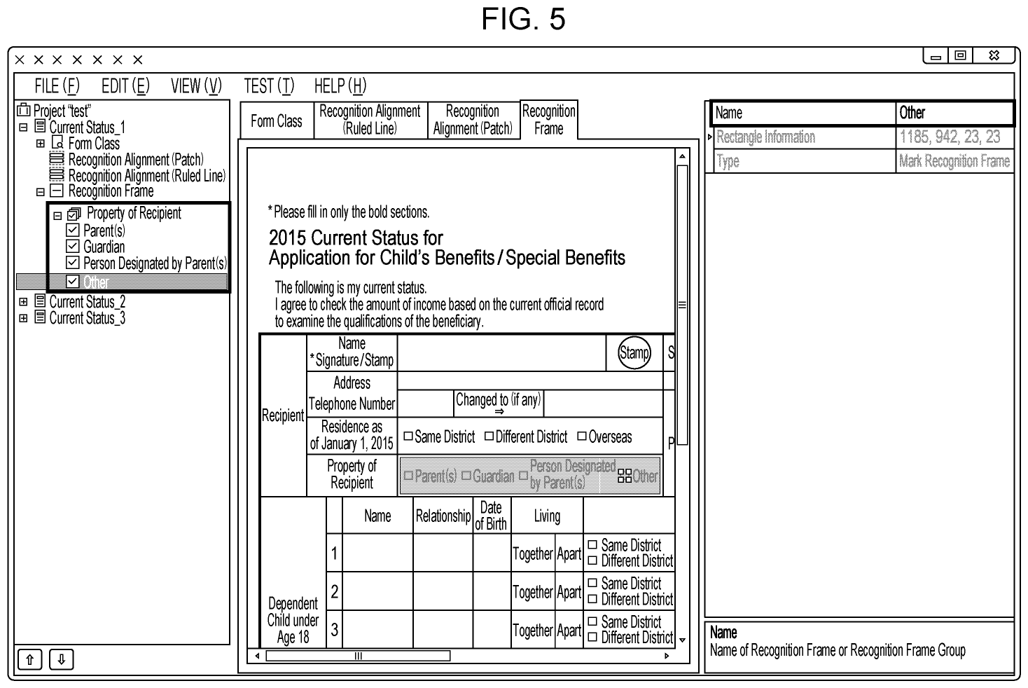

Then, as illustrated in FIG. 4, a human operator (e.g., the system administrator SE) manually inputs the phrase “Property of Recipient” to the main item “MarkField1” as the group name of the main item. Further, as illustrated in FIG. 5, the human operator manually inputs the words “Parent(s)”, “Guardian”, “Person Designated by Parent(s)”, and “Other” to the sub-items “Id0”, “Id1”, “Id2”, and “Id3”, respectively, as the item names of the sub-items.

In this comparative example, the human operator manually inputs the group names of main items and the item names of sub-items individually. The human operator further makes a definition for each group and repeats a series of procedures, starting from the selection of “Auto Detect” and “Check Mark” in the menu displayed by a right click with the mouse, a number of times equal to the number of groups.

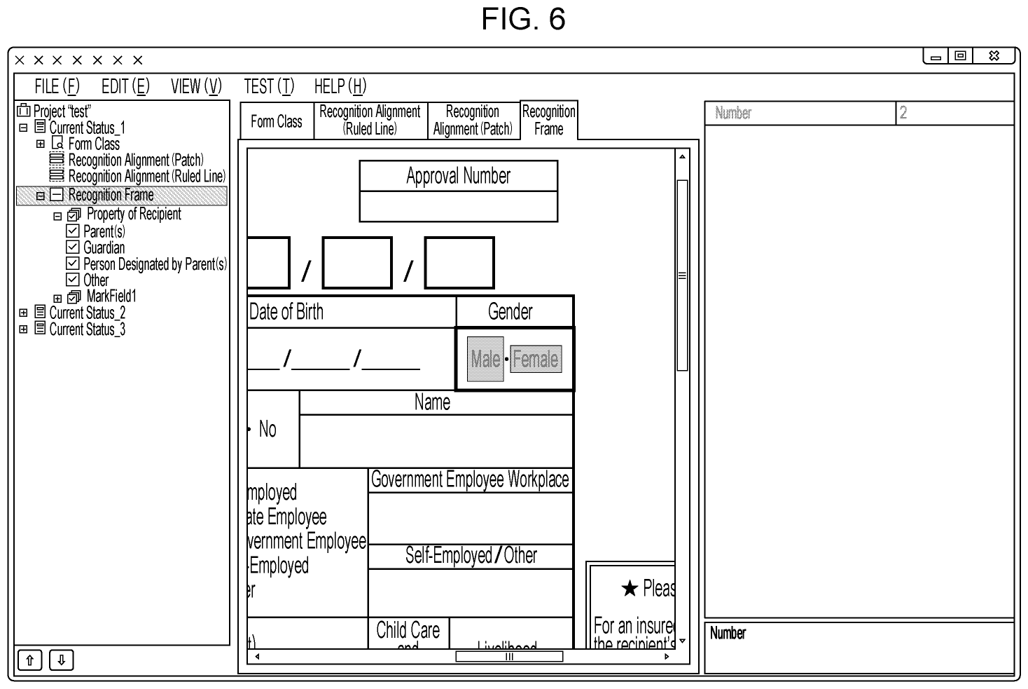

FIGS. 6 to 9 illustrate a method for defining an item having a plurality of character strings around which borders are applicable according to a comparative example.

For example, as illustrated in FIG. 6, a menu is displayed by a right click on a displayed form image with a mouse (not illustrated). Then, “Create” and “Mark” are selected in the menu, and the range to be defined is selected by a drag-and-drop action. In the case of options to be enclosed in borders, a selected frame is defined as a frame because of no frame to be filled in (i.e., no check box). As an example, as indicated by “Male” and “Female” in FIG. 6, the selection of the range to be defined by a drag-and-drop action is repeatedly performed a number of times equal to the number of items. In FIG. 6, “Male” and “Female” represent option character strings.

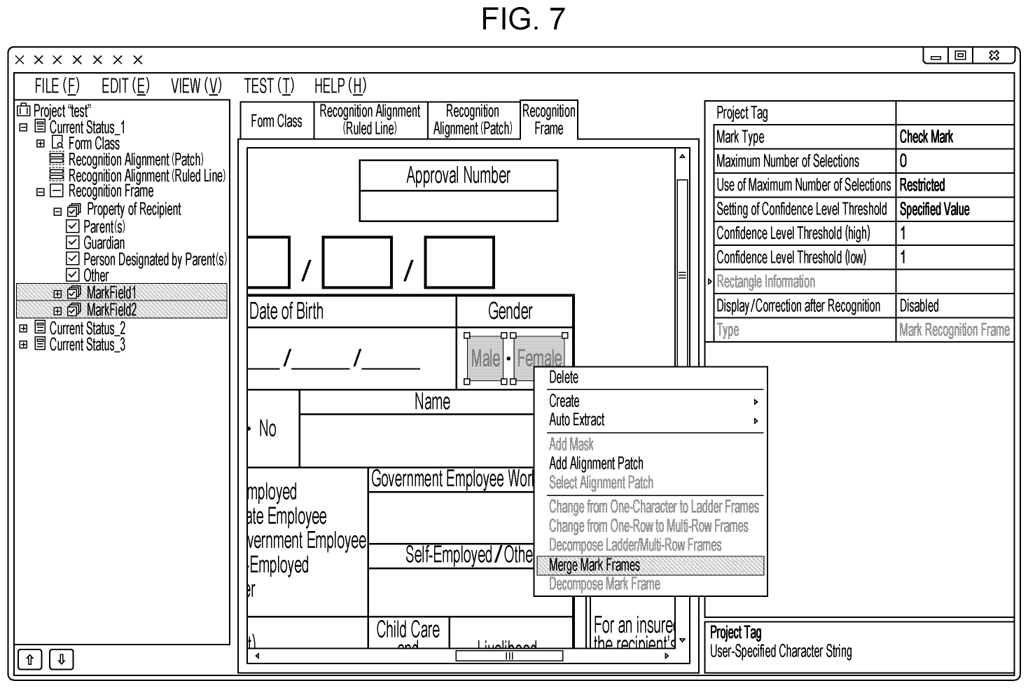

Then, as illustrated in FIG. 7, a plurality of sub-items in the same group (in the example illustrated in FIG. 7, “Male” and “Female”) are selected, and “Merge Mark Frames” is selected in a mouse right-click menu.

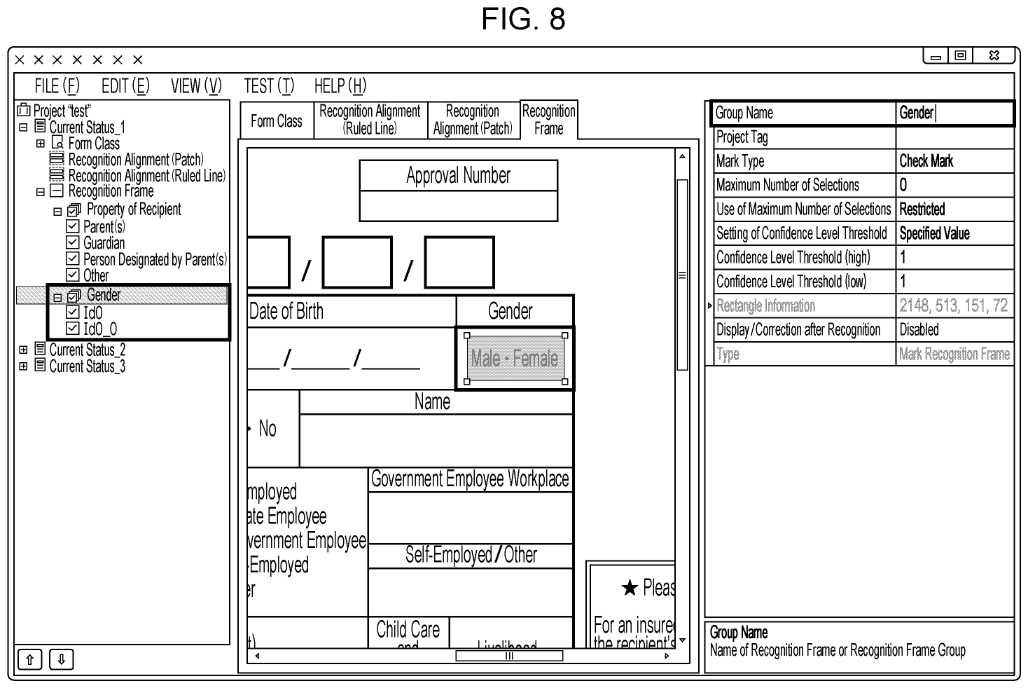

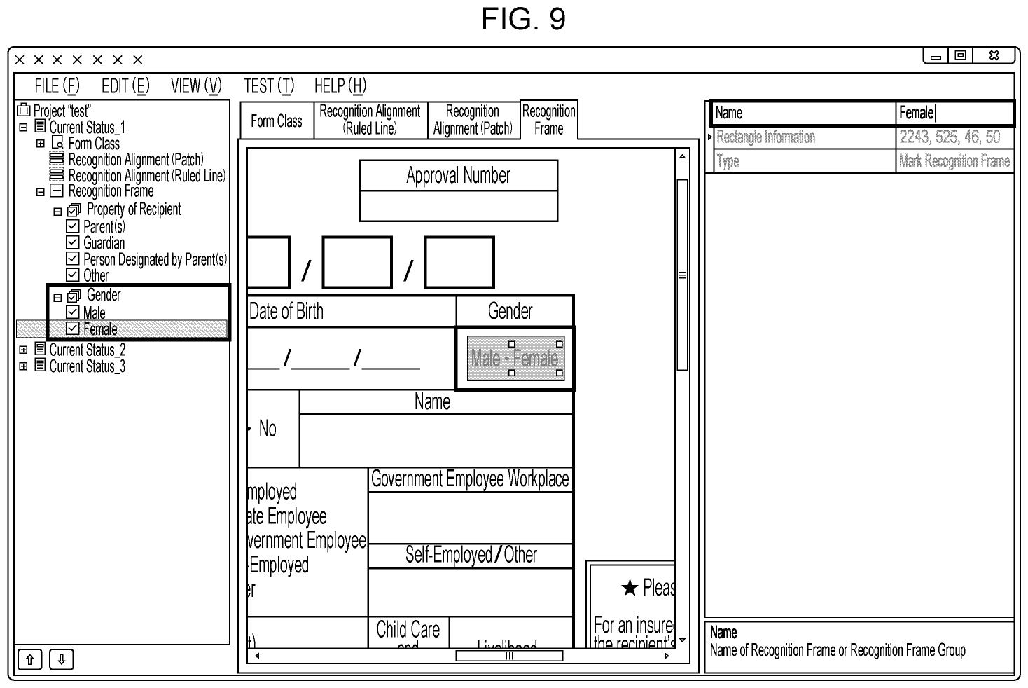

Then, as illustrated in FIG. 8, the human operator manually inputs the word “Gender” as the group name of the main item. At this time, the human operator manually adjusts the size of a selected frame including the sub-items. Accordingly, frames for the sub-items “Id0” and “Id0_0” corresponding to “Male” and “Female”, respectively, are generated. Then, as illustrated in FIG. 9, the human operator manually inputs the words “Male” and “Female” to the sub-items “Id0” and “Id0_0” as the item names of the sub-items, respectively.

In this comparative example, the human operator manually inputs the group names of main items and the item names of sub-items individually. In the case of options to be enclosed in borders, furthermore, the human operator defines a selected frame as a frame because of no frame to be filled in. In addition, the human operator repeats the operation of defining a selected frame as a frame a number of times equal to the number of items. Moreover, the human operator manually adjusts the size of a selected frame including sub-items.

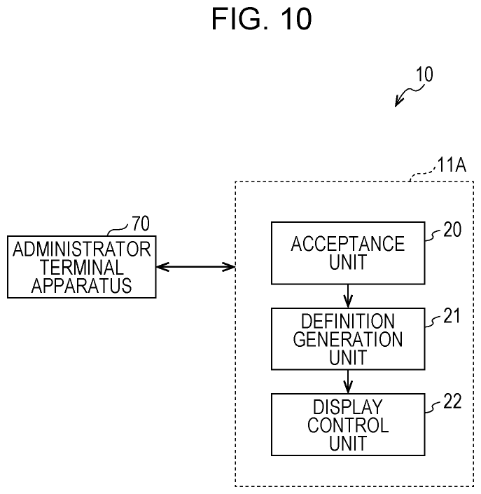

In contrast to the comparative example described above, the CPU 11A of the server apparatus 10 according to this exemplary embodiment loads the information processing program 12A stored in the storage unit 12 into the RAM 11C and executes the information processing program 12A, thereby functioning as the components illustrated in FIG. 10. The CPU 11A is an example of a processor.

FIG. 10 is a block diagram illustrating an example functional configuration of the server apparatus 10 according to this exemplary embodiment.

As illustrated in FIG. 10, the CPU 11A of the server apparatus 10 according to this exemplary embodiment functions as an acceptance unit 20, a definition generation unit 21, and a display control unit 22.

To define a form image to be recognized, the acceptance unit 20 accepts the designation of an area including an item contained in the form image and a set of options for the item. In the example illustrated in FIG. 3 described above, the item is “Property of Recipient”, and the set of options for the item is a plurality of check boxes. The names of the options identified by the plurality of check boxes are “Parent(s)”, “Guardian”, “Person Designated by Parent(s)”, and “Other”. In the example illustrated in FIG. 6 described above, the item is “Gender”, and the set of options for the item is a plurality of character strings. The plurality of character strings are “Male” and “Female”, which are the names of the options. The illustrated form image has a plurality of frames, by way of example. Examples of the options include a plurality of check boxes to which check marks are applicable, and a plurality of character strings around which borders are applicable. The term “character string”, as used herein, refers to a set of one or more characters including a letter, a number, a symbol, and so on. The acceptance unit 20 may accept the designation of an area including a plurality of check boxes and a plurality of character strings. The area may be designated by using a drag-and-drop operation with a mouse, pointing diagonally opposing corners with a mouse, or any other method.

The definition generation unit 21 associates a frame including an item with a frame containing a set of options. The frame including the item may be a neighboring frame of the frame containing the set of options. The term “neighboring frame” of a given frame, as used herein, may be used to indicate an adjoining frame of the given frame or a frame spaced a certain distance from the given frame. The definition generation unit 21 may associate, with a frame containing a set of options, a neighboring frame that is located near the frame containing the set of options and that includes a single character string, as a frame including an item.

If the set of options is identified by a plurality of check boxes to which check marks are applicable, the definition generation unit 21 detects ruled lines included in the area and divides the area into a plurality of groups using the detected ruled lines. Non-limiting examples of the method for detecting ruled lines include Hough transform, line segment detector (LSD), and other known methods. The definition generation unit 21 extracts an item group and an option group from among the plurality of groups such that the item group includes no check box and includes a single character string, and the option group includes a plurality of check boxes and a plurality of character strings each arranged adjacent to one of the check boxes. Each check box may be detected using a known technique of detecting a rectangle, by way of example. Each character string may be detected using recognition technology such as OCR, by way of example.

If the set of options is identified by a plurality of character strings around which borders are applicable, the definition generation unit 21 detects ruled lines included in the area in a way similar to that described above and divides the area into a plurality of groups using the detected ruled lines. In the case of options to be enclosed in borders, as an example, the definition generation unit 21 detects only a set of thickest ruled lines and divides the area into groups using the detected ruled lines. The definition generation unit 21 may have a function of manually dividing the area into groups again if the initially obtained groups are not the desired ones. In the case of options to be enclosed in borders, whether each of the groups obtained by dividing the area is an item group or an option group is determined according to the number of character strings, by way of example. Specifically, the definition generation unit 21 extracts, as an item group, a group including no check box and including a single character string, and, as an option group, a group including no check box and including a plurality of character strings from among the plurality of groups. The determination of a plurality of character strings is based on the presence or absence of a separator between characters (such as punctuation, dash, or space), by way of example.

In the case of options to be enclosed in borders, furthermore, the number of columns of groups and the layout of the groups may be used to determine whether each group is an item group or an option group. Specifically, the definition generation unit 21 may extract, as an item group, a group in a single column, which includes no check box and includes a single character string, and, as option groups, groups in a plurality of columns below the item group from among a plurality of groups. In the groups in the plurality of columns, no check box is included in each column and a single character string is included in each column. It is noted that the columns are vertical arrangements of cells in the form image.

The definition generation unit 21 associates an item with a set of options such that a character string of the item is defined as the item name (group name) and a character string of each of the options is defined as an option name.

For example, the display control unit 22 controls the administrator terminal apparatus 70 to display the definition that associates the item with the set of options, which is generated by the definition generation unit 21. At this time, the display control unit 22 may control the administrator terminal apparatus 70 to also display recognition results of the item name related to the item and the option names related to the options. In this case, the acceptance unit 20 may perform control to receive any correction of the recognition results of the item name related to the item and the option names related to the options.

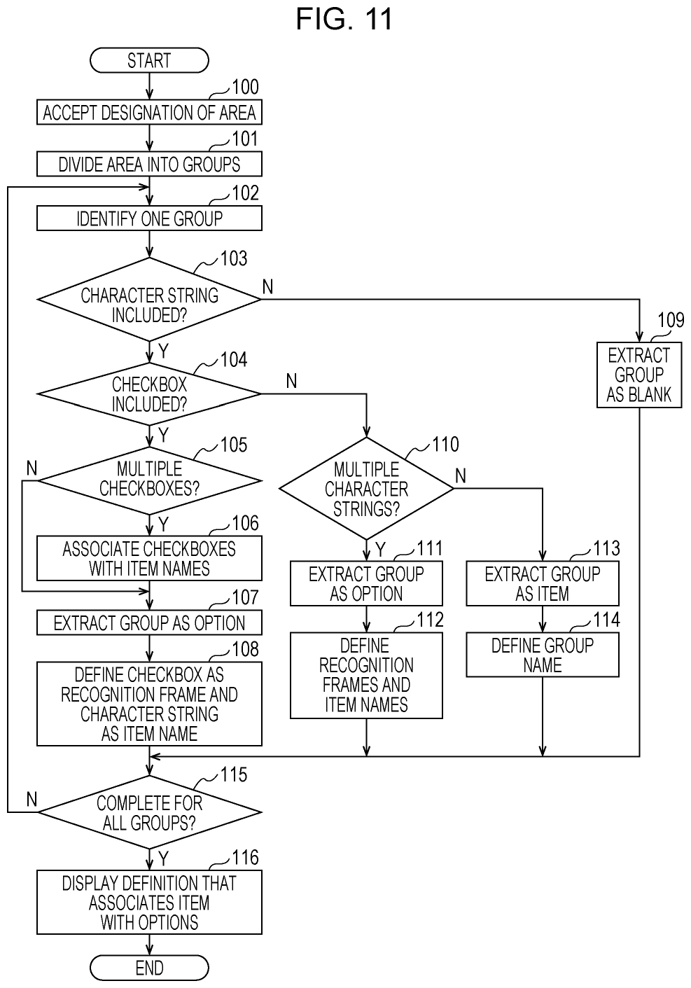

Next, the operation of the server apparatus 10 according to this exemplary embodiment will be described with reference to FIG. 11.

FIG. 11 is a flowchart illustrating an example flow of a process performed in accordance with the information processing program 12A according to this exemplary embodiment.

First, when the server apparatus 10 is instructed to execute a form definition process, the CPU 11A starts the information processing program 12A and executes the following steps.

Referring to FIG. 11, in step 100, the CPU 11A accepts the designation of an area including an item and a set of options in a form image displayed on the administrator terminal apparatus 70, for example. As described above, the area is designated by using a drag-and-drop operation with a mouse, pointing diagonally opposing corners with a mouse, or any other method.

In step 101, the CPU 11A divides the area for which the designation is accepted in step 100 into a plurality of groups on a frame-by-frame basis. As described above, the area is divided into groups by detecting ruled lines included in the area.

In step 102, the CPU 11A identifies one of the plurality of groups obtained in step 101.

In step 103, the CPU 11A determines whether the group identified in step 102 includes a character string. As described above, a character string is detected using recognition technology such as OCR. If it is determined that the group includes a character string (if positive determination is obtained), the CPU 11A proceeds to step 104. If it is determined that the group includes no character string (if negative determination is obtained), the CPU 11A proceeds to step 109.

In step 104, the CPU 11A determines whether the group identified in step 102 includes a check box. As described above, a check box is detected using a known technique for detecting a rectangle. If it is determined that the group includes a check box (if positive determination is obtained), the CPU 11A proceeds to step 105. If it is determined that the group includes no check box (if negative determination is obtained), the CPU 11A proceeds to step 110.

In step 105, the CPU 11A determines whether the group includes a plurality of check boxes. If it is determined that the group includes a plurality of check boxes (if positive determination is obtained), the CPU 11A proceeds to step 106. If it is determined that the group does not include a plurality of check boxes (if negative determination is obtained), the CPU 11A proceeds to step 107.

In step 106, the CPU 11A associates each of the check boxes with an item name. For example, the CPU 11A associates a character string located to the right of each of the check boxes with the item name related to the check box.

In step 107, the CPU 11A extracts the group identified in step 102, as an option group including a check box(es) and a character string(s).

In step 108, the CPU 11A defines, in the group extracted as an option group in step 107, the check box(es) as a recognition frame(s) and the character string(s) as an item name(s). Then, the CPU 11A proceeds to step 115.

On the other hand, in step 109, the CPU 11A extracts the group identified in step 102, as a blank field not filled in. Then, the CPU 11A proceeds to step 115.

In step 110, the CPU 11A determines whether the group includes a plurality of character strings. The determination of whether a plurality of character strings are included is based on the presence or absence of a separator between characters (such as punctuation, dash, or space), as described above. If it is determined that the group includes a plurality of character strings (if positive determination is obtained), the CPU 11A proceeds to step 111. If it is determined that the group does not include a plurality of character strings (if negative determination is obtained), the CPU 11A proceeds to step 113.

In step 111, the CPU 11A extracts the group identified in step 102, as an option group including a plurality of character strings.

In step 112, the CPU 11A defines, in the group extracted as an option group in step 111, a selected frame for each of the plurality of character strings as a recognition frame and defines each of the plurality of character strings as an item name. Then, the CPU 11A proceeds to step 115.

On the other hand, in step 113, the CPU 11A extracts the group identified in step 102, as an item group.

In step 114, the CPU 11A defines, in the group extracted as an item group in step 113, a character string of the item as a group name. Then, the CPU 11A proceeds to step 115.

In step 115, the CPU 11A determines whether the process is complete for all of the groups. If it is determined that the process is complete for all of the groups (if positive determination is obtained), the CPU 11A proceeds to step 116. If it is determined that the process is not complete for all of the groups (if negative determination is obtained), the CPU 11A returns to step 102, and repeatedly performs the process.

In step 116, the CPU 11A displays a definition that associates an item with a set of options on, for example, the administrator terminal apparatus 70. Then, the series of processing operations performed in accordance with the information processing program 12A ends.

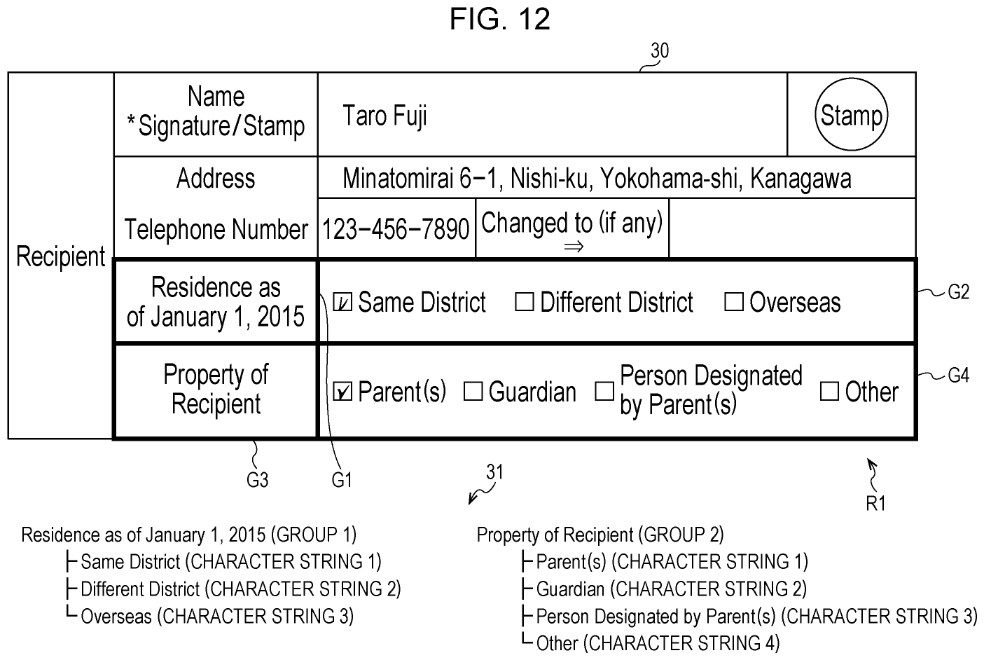

Next, a method for defining an item and a set of options to be checked by check marks in association with each other will be described in detail with reference to FIGS. 12 to 15.

FIG. 12 illustrates an example of a form image 30 and an option definition 31 for options to be checked by check marks according to this exemplary embodiment.

The form image 30 illustrated in FIG. 12 is a portion of the form image illustrated in FIG. 3 described above. In the form image 30, a designated area R1 is divided into a plurality of groups G1 to G4. The group G1 is a group extracted as an item group, and the group G2 is a group extracted as an option group including a plurality of check boxes and a plurality of character strings. The group G2 is associated with the group G1. Likewise, the group G3 is a group extracted as an item group, and the group G4 is a group extracted as an option group including a plurality of check boxes and a plurality of character strings. The group G4 is associated with the group G3.

In the option definition 31 illustrated in FIG. 12, the character string in the group G1 (in the example illustrated in FIG. 12, “Residence as of Jan. 1, 2015”) is defined as a group name, and the plurality of character strings in the group G2 (in the example illustrated in FIG. 12, “Same District”, “Different District”, and “Overseas”) are defined as option names. The group G1 and the group G2 are associated with each other to form group 1. Likewise, the character string in the group G3 (in the example illustrated in FIG. 12, “Property of Recipient”) is defined as a group name, and the plurality of character strings in the group G4 (in the example illustrated in FIG. 12, “Parent(s)”, “Guardian”, “Person Designated by Parent(s)”, and “Other”) are defined as option names. The group G3 and the group G4 are associated with each other to form group 2.

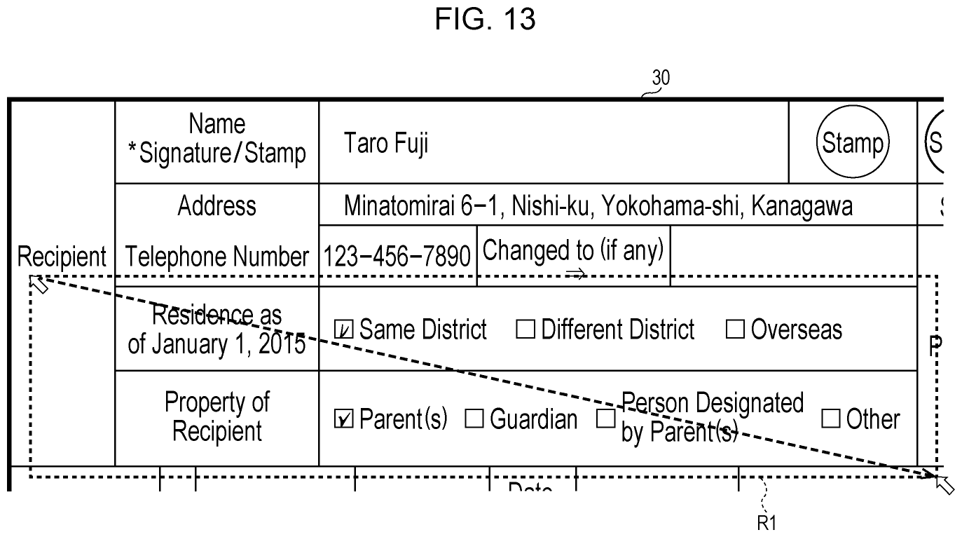

FIG. 13 illustrates an example of the form image 30 according to this exemplary embodiment in which the area R1 is designated.

As illustrated in FIG. 13, the area R1 is designated by, for example, clicking on a point and dragging it across the range to be defined in the form image 30. The area R1 may be designated by pointing diagonally opposing corners with a mouse.

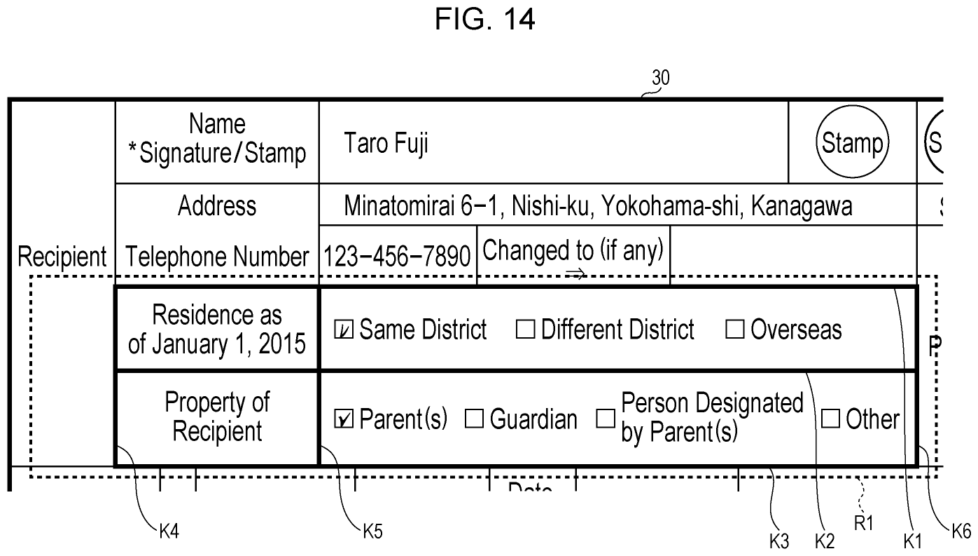

FIG. 14 illustrates an example of the form image 30 according to this exemplary embodiment in which ruled lines K1 to K6 are detected from within the area R1.

As illustrated in FIG. 14, when the area R1 is designated in the form image 30, ruled lines K1 to K6 are detected within the designated area R1. The ruled lines K1 to K6 may be detected using Hough transform, LSD, or any other known method, by way of example.

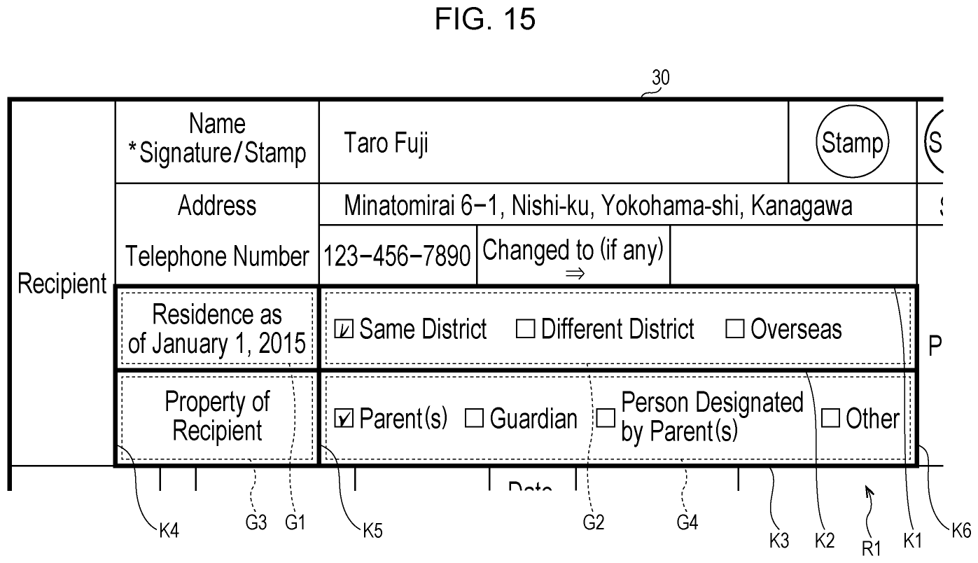

FIG. 15 illustrates an example of the form image 30 according to this exemplary embodiment in which the area R1 is divided into the plurality of groups G1 to G4.

As illustrated in FIG. 15, when the ruled lines K1 to K6 are detected from within the area R1 in the form image 30, the area R1 is divided into the plurality of groups G1 to G4 using the ruled lines K1 to K6.

The group G1, which is a group including no check box and including a single character string, is extracted as an item group. In the group G1, the character string of the item is defined as a group name. The group G2, which includes a plurality of check boxes and a plurality of character strings each arranged adjacent to one of the check boxes, is extracted as an option group. In the group G2, check boxes are defined, and a character string associated with each of the check boxes is defined as an option name. Likewise, the group G3, which is a group including no check box and including a single character string, is extracted as an item group. In the group G3, the character string of the item is defined as a group name. The group G4, which includes a plurality of check boxes and a plurality of character strings each arranged adjacent to one of the check boxes, is extracted as an option group. In the group G4, check boxes are defined, and a character string associated with each of the check boxes is defined as an option name.

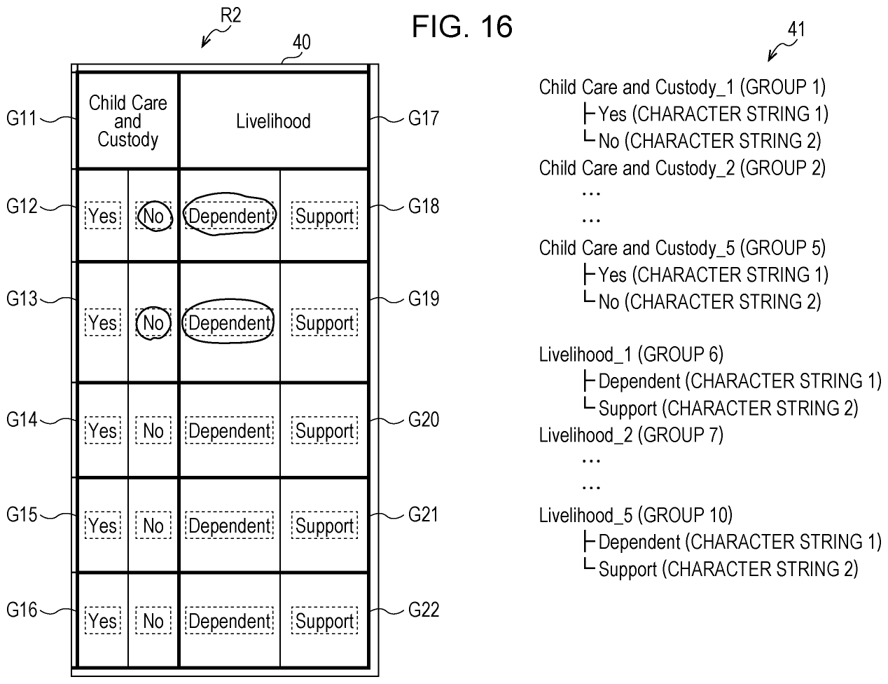

Next, a method for defining an item and a set of options to be enclosed in borders in association with each other will be described in detail with reference to FIGS. 16 to 19.

FIG. 16 illustrates an example of a form image 40 and an option definition 41 for options to be enclosed in borders according to this exemplary embodiment.

The form image 40 illustrated in FIG. 16 is a portion of the form image illustrated in FIG. 6 described above. In the form image 40, a designated area R2 is divided into a plurality of groups G11 to G22. The group G11 is a group extracted as an item group. The groups G12 to G16 are each a group extracted as an option group including no check box and including a plurality of character strings. Each of the groups G12 to G16 is associated with the group G11. Likewise, the group G17 is a group extracted as an item group. The groups G18 to G22 are each a group extracted as an option group including no check box and including a plurality of character strings. Each of the groups G18 to G22 is associated with the group G17.

In the option definition 41 illustrated in FIG. 16, the character string in the group G11 (in the example illustrated in FIG. 16, “Child Care and Custody”) is defined as a group name, and a plurality of character strings in each of the groups G12 to G16 (in the example illustrated in FIG. 16, “Yes” and “No”) are defined as option names. If a plurality of groups have the same name, the names of the groups are assigned serial numbers such as 1, 2, etc. That is, the groups G12 to G16 are associated with the group G11 to form groups 1 to 5 such that the group G12 is associated with the group G11 to form group 1, the group G13 is associated with the group G11 to form group 2, the group G14 is associated with the group G11 to form group 3, the group G15 is associated with the group G11 to form group 4, and the group G16 is associated with the group G11 to form group 5. Likewise, the character string in the group G17 (in the example illustrated in FIG. 16, “Livelihood”) is defined as a group name, and a plurality of character strings in each of the groups G18 to G22 (in the example illustrated in FIG. 16, “Dependent” and “Support”) are defined as option names. In this case, the groups G18 to G22 are associated with the group G17 to form groups 6 to 10 such that the group G18 is associated with the group G17 to form group 6, the group G19 is associated with the group G17 to form group 7, the group G20 is associated with the group G17 to form group 8, the group G21 is associated with the group G17 to form group 9, and the group G22 is associated with the group G17 to form group 10.

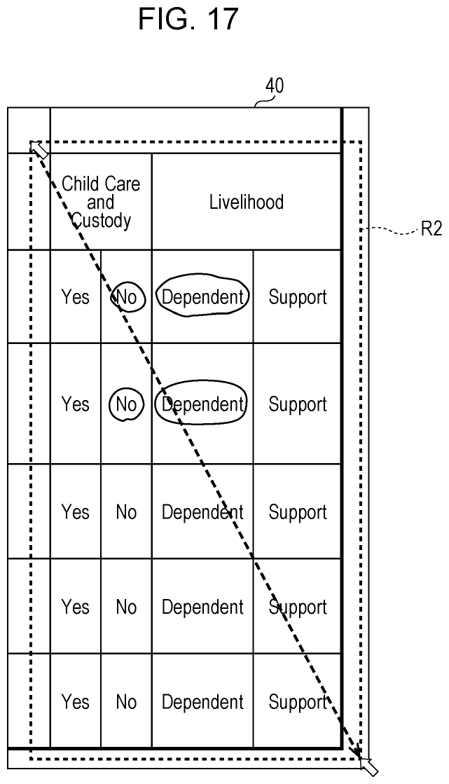

FIG. 17 illustrates an example of the form image 40 according to this exemplary embodiment in which the area R2 is designated.

As illustrated in FIG. 17, the area R2 is designated by, for example, clicking on a point and dragging it across the range to be defined in the form image 40. The area R2 may be designated by pointing diagonally opposing corners with a mouse.

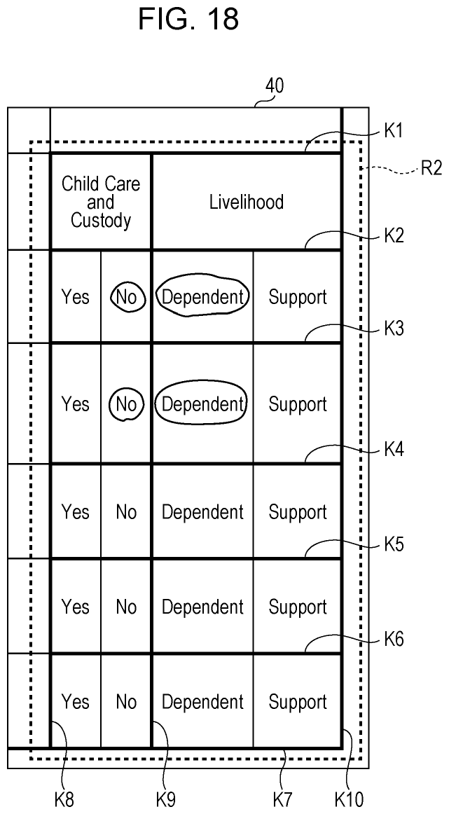

FIG. 18 illustrates an example of the form image 40 according to this exemplary embodiment in which ruled lines K1 to K10 are detected from within the area R2.

As illustrated in FIG. 18, when the area R2 is designated in the form image 40, ruled lines K1 to K10 are detected within the designated area R2. The ruled lines K1 to K10 may be detected using Hough transform, LSD, or any other known method, by way of example. In the example illustrated in FIG. 18, among the plurality of ruled lines included in the area R2, only a set of thickest ruled lines is detected.

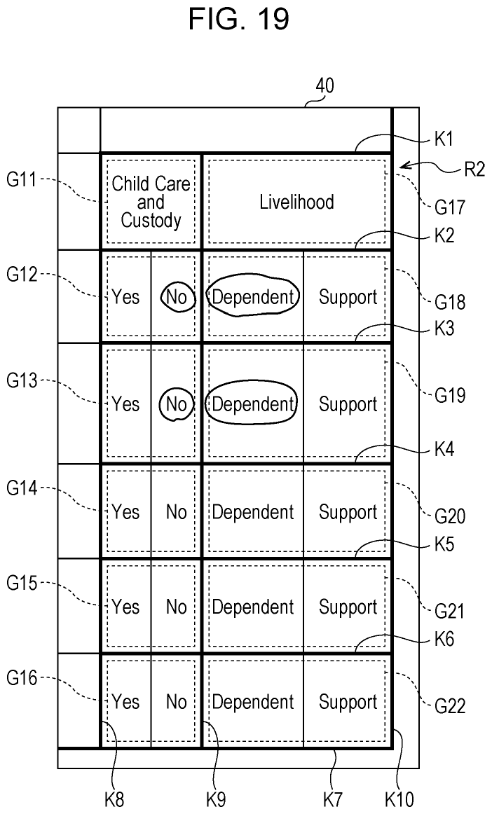

FIG. 19 illustrates an example of the form image 40 according to this exemplary embodiment in which the area R2 is divided into the plurality of groups G11 to G22.

As illustrated in FIG. 19, when the ruled lines K1 to K10 are detected from within the area R2 in the form image 40, the area R2 is divided into the plurality of groups G11 to G22 using the ruled lines K1 to K10.

The group G11, which is a group including no check box and including a single character string, is extracted as an item group. In the group G11, the character string of the item is defined as a group name. The groups G12 to G16, each of which includes no check box and includes a plurality of character strings, are extracted as option groups. In each of the groups G12 to G16, character strings around which borders are applicable are defined, and the character strings are defined as option names. Likewise, the group G17, which is a group including no check box and including a single character string, is extracted as an item group. In the group G17, the character string of the item is defined as a group name. The groups G18 to G22, each of which includes no check box and includes a plurality of character strings, are extracted as option groups. In each of the groups G18 to G22, character strings around which borders are applicable are defined, and the character strings are defined as option names.

Alternatively, as described above, among the plurality of groups G11 to G22, the group G11 in a column including no check box and including a single character string (in the example illustrated in FIG. 19, “Child Care and Custody”) may be defined as an item group, and the groups G12 to G16 in a plurality of columns below the group G11, which is an item group, may be extracted as option groups. In the groups G12 to G16 in the plurality of columns, no check box is included in each column, and a single character string (in the example illustrated in FIG. 19, “Yes” or “No”) is included in each column. Likewise, the group G17 in a column including no check box and including a single character string (in the example illustrated in FIG. 19, “Livelihood”) may be defined as an item group, and the groups G18 to G22 in a plurality of columns below the group G17, which is an item group, may be extracted as option groups. In the groups G18 to G22 in the plurality of columns, no check box is included in each column, and a single character string (in the example illustrated in FIG. 19, “Dependent” or “Support”) is included in each column.

In this exemplary embodiment, accordingly, when a form image contains items each having a set of options, in response to acceptance of designation of an area including an item and a set of options for the item, a definition that associates the item with the set of options is displayed. If the set of options is a plurality of check boxes to which check marks are applicable, the option definition 31 illustrated in FIG. 12 is displayed, by way of example. If the set of options is a plurality of character strings around which borders are applicable, the option definition 41 illustrated in FIG. 16 is displayed, by way of example.

In the embodiment above, the term “processor” refers to hardware in a broad sense. Examples of the processor includes general processors (e.g., CPU: Central Processing Unit), dedicated processors (e.g., GPU: Graphics Processing Unit, ASIC: Application Integrated Circuit, FPGA: Field Programmable Gate Array, and programmable logic device).

In the embodiment above, the term “processor” is broad enough to encompass one processor or plural processors in collaboration which are located physically apart from each other but may work cooperatively. The order of operations of the processor is not limited to one described in the embodiment above, and may be changed.

In the foregoing description, a server apparatus is exemplified as an example of an information processing apparatus according to an exemplary embodiment. Exemplary embodiments may be implemented using a program for causing a computer to execute the functions of the components of the server apparatus. Exemplary embodiments may be implemented using a computer-readable non-transitory storage medium storing the program described above.

In addition, the configuration of the server apparatus provided in the exemplary embodiment described above is an example, and may be modified depending on the situation without departing from the spirit of the present disclosure.

In addition, the flow of the processes of the program provided in the exemplary embodiment described above is also an example. An unnecessary step may be deleted, a new step may be added, or the processing order may be changed without departing from the spirit of the present disclosure.

In the exemplary embodiment described above, furthermore, a program is executed to implement the processes according to the exemplary embodiment by a software configuration using a computer, by way of example without limitation. The exemplary embodiment may be implemented by a hardware configuration or a combination of a hardware configuration and a software configuration, for example.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising a processor configured to:
accept designation of an area including an item and a set of one or more options for the item, the item being contained in a form image to be recognized, to define the form image;
extract the item and the set of one or more options from the area; and
perform control to display a definition that associates the item with the set of one or more options.

2. The information processing apparatus according to claim 1, wherein the set of one or more options comprises a plurality of check boxes to which check marks are applicable, or a plurality of character strings around which borders are applicable.

3. The information processing apparatus according to claim 2, wherein the processor is further configured to accept designation of an area including the plurality of check boxes and the plurality of character strings.

4. The information processing apparatus according to claim 1, wherein the processor is further configured to perform control to display a recognition result obtained by recognizing an item name related to the item and a recognition result obtained by recognizing one or more option names related to the set of one or more options.

5. The information processing apparatus according to claim 2, wherein the processor is further configured to perform control to display a recognition result obtained by recognizing an item name related to the item and a recognition result obtained by recognizing one or more option names related to the set of one or more options.

6. The information processing apparatus according to claim 3, wherein the processor is further configured to perform control to display a recognition result obtained by recognizing an item name related to the item and a recognition result obtained by recognizing one or more option names related to the set of one or more options.

7. The information processing apparatus according to claim 4, wherein the processor is further configured to perform control to receive a correction of the recognition result obtained by recognizing the item name and the recognition result obtained by recognizing the one or more option names.

8. The information processing apparatus according to claim 5, wherein the processor is further configured to perform control to receive a correction of the recognition result obtained by recognizing the item name and the recognition result obtained by recognizing the one or more option names.

9. The information processing apparatus according to claim 6, wherein the processor is further configured to perform control to receive a correction of the recognition result obtained by recognizing the item name and the recognition result obtained by recognizing the one or more option names.

10. The information processing apparatus according to claim 1,
wherein the form image includes a plurality of frames, and
wherein the processor is further configured to associate a frame including the item with a frame including the set of one or more options among the plurality of frames, the frame including the item being a neighboring frame of the frame including the set of one or more options.

11. The information processing apparatus according to claim 10, wherein the processor is further configured to associate a neighboring frame that is located near the frame including the set of one or more options and that includes a single character string, as the frame including the item, with the frame including the set of one or more options.

12. The information processing apparatus according to claim 1,
wherein the set of one or more options comprises a plurality of check boxes to which check marks are applicable, and
wherein the processor is further configured to:
detect one or more ruled lines included in the area;
divide the area into a plurality of groups using the one or more ruled lines; and
extract a group indicating the item and a group indicating the set of one or more options from among the plurality of groups such that a group including no check box and including a single character string is extracted as the group indicating the item and a group including a plurality of check boxes and a plurality of character strings each arranged adjacent to one of the check boxes is extracted as the group indicating the set of one or more options.

13. The information processing apparatus according to claim 1,
wherein the set of one or more options comprises a plurality of character strings around which borders are applicable, and
wherein the processor is further configured to:
detect one or more ruled lines included in the area;
divide the area into a plurality of groups using the one or more ruled lines; and
extract a group indicating the item and a group indicating the set of one or more options from among the plurality of groups such that a group including no check box and including a single character string is extracted as the group indicating the item and a group including no check box and including a plurality of character strings is extracted as the group indicating the set of one or more options.

14. The information processing apparatus according to claim 13, wherein the processor is further configured to determine the plurality of character strings, the determination being based on presence or absence of a separator between characters.

15. The information processing apparatus according to claim 1,
wherein the set of one or more options comprises a plurality of character strings around which borders are applicable, and
wherein the processor is further configured to:
detect one or more ruled lines included in the area;
divide the area into a plurality of groups using the one or more ruled lines; and
extract a group indicating the item and a group indicating the set of one or more options from among the plurality of groups such that a group in a column including no check box and including a single character string is extracted as the group indicating the item and groups in a plurality of columns below the group indicating the item in which no check box is included in each of the plurality of columns and a single character string is included in each of the plurality of columns are extracted as the group indicating the set of one or more options.

16. A non-transitory computer readable medium storing a program causing a computer to execute a process for information processing, the process comprising:
accepting designation of an area including an item and a set of one or more options for the item, the item being contained in a form image to be recognized, to define the form image;
extracting the item and the set of one or more options from the area; and
performing control to display a definition that associates the item with the set of one or more options.

17. An information processing apparatus comprising:
means for accepting designation of an area including an item and a set of one or more options for the item, the item being contained in a form image to be recognized, to define the form image;
means for extracting the item and the set of one or more options from the area; and
means for performing control to display a definition that associates the item with the set of one or more options.
